(19) United States
(12) Patent Application Publication
(10) Pub. No.: US 2020/0134503 A1
(43) Pub. Date: Apr. 30, 2020

(54) QUANTUM COMPUTING SYSTEM AND METHOD

(71) Applicant: Black Brane Systems Inc., Toronto (CA)

(72) Inventor: Colin J.E. Lupton, Toronto (CA)

(73) Assignee: Black Brane Systems Inc., Toronto (CA)

(21) Appl. No.: 16/665,180

(22) Filed: Oct. 28, 2019

Related U.S. Application Data
(60) Provisional application No. 62/753,623, filed on Oct. 31, 2018.

(51) Int. Cl. G06N 10/00; G06N 7/08; G06N 5/00; G06N 20/10

(52) U.S. Cl. CPC G06N 10/00; G06N 20/10; G06N 5/003; G06N 7/08

(57) ABSTRACT

In various embodiments, A quantum computing system comprises at least one classical processor configured by operational instructions stored in a classical memory to perform operations including: generating a qubit encoding from an input, wherein the qubit encoding indicates a sublattice of a projective Riemann-hypersphere that represents a plurality of qubits; and generating a quantum solution based on quantum calculations wherein the quantum calculations include a decomposition of the sublattice performed via a plurality of iterations.

### CROSS REFERENCE TO RELATED APPLICATIONS

The present U.S. Utility Patent Application claims priority pursuant to 35 U.S.C. § 119(e) to U.S. Provisional Application No. 62/753,623, entitled “QUANTUM COMPUTING SYSTEM AND METHOD”, filed Oct. 31, 2018, which is hereby incorporated herein by reference in its entirety and made part of the present U.S. Utility Patent Application for all purposes.

### BACKGROUND OF THE INVENTION

### Technical Field of the Invention

This invention relates generally to computer systems and more particularly to quantum computing.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a processor, a memory system, user input/output interfaces, peripheral device interfaces, and an interconnecting bus structure.

Classical digital computing devices operate based on data encoded into binary digits (bits), each of which has one of the two definite binary states (i.e., 0 or 1). In contrast, a quantum computer utilizes quantum-mechanical phenomena to represent data as quantum bits or qubits, which can be in superpositions of the traditional binary states. Traditional quantum computing is based on a Bloch sphere representation of a qubit. The Bloch sphere is a unit 2-sphere, with antipodal points corresponding to a pair of mutually orthogonal state vectors. The north and south poles of the Bloch sphere are typically chosen to correspond to the standard basis vectors of the qubit corresponding to, for example, the spin-up and spin-down states of an electron.

### BRIEF DESCRIPTION OF THE SEVERAL VIEWS OF THE DRAWING(S)

FIG. 1 is a schematic block diagram of an embodiment of a quantum computing system in accordance with the present invention;

FIG. 2 is a schematic block diagram of an embodiment of a virtual quantum computing engine in accordance with the present invention; and

FIG. 3 is a flow diagram of an embodiment of a method in accordance with the present invention.

FIG. 4 is a flow diagram of an embodiment of a method in accordance with the present invention.

### DETAILED DESCRIPTION OF THE INVENTION

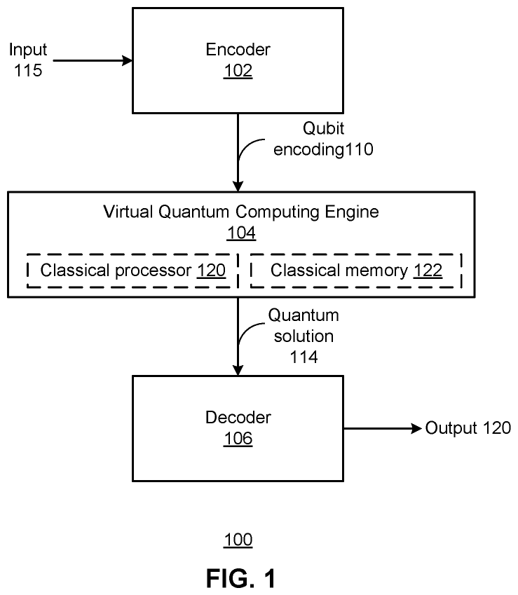

FIG. 1 is a schematic block diagram 100 of an embodiment of a quantum computing system in accordance with the present invention. In particular, the quantum computing system includes an encoder 102 configured to generate a qubit encoding 110 based on an input 115. A virtual quantum computing engine 104 includes classical memory 122 that stores a quantum chaos knowledgebase that includes, for example a knowledgebase of quantum states that have been harvested from one or more physical quantum systems. The virtual quantum computing engine 104 is configured to process the qubit encoding 110 to generate a quantum solution 114 using quantum calculations and/or based on quantum chaos generated in accordance with the quantum chaos knowledgebase. A decoder 106 generates an output 120, based on the quantum solution 114. In various embodiments, the quantum solution 114 is the classical computing solution to the input 115, determined via sampling the qubits that, for example, collapses the quantum solution to a classical computing result—demonstrating the Principle of Deferred Measurement in the virtual quantum computing engine 104. The decoder 106 can operate to further process or format the quantum solution 114 to generate the output 120 in a desired format. In various embodiments the output 120 can be merely the quantum solution 114 and the decoder 106 can be omitted.

In various embodiments, the virtual quantum computing engine 104 includes a classical processor 120. In addition, the encoder 102 and the decoder 106 can also be implemented by via a classical processor 120 or one or more other processing devices. Furthermore, while the encoder 102 and decoder 106 are shown as being separate from the virtual quantum computing engine 104, in various embodiments, the encoder 102 and decoder 106 can each be implemented via the virtual quantum computing engine 104, for example, via the classical processor 120 configured by instructions stored in classical memory 122. The classical processor 120 can include a processing device and/or one or more classical virtual machines, including but not limited to the WebAssembly virtual machine included in web browsers, the Java Virtual Machine, IoT devices, and distributed compute clusters, etc. Each such processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element such as classical memory 122 or other memory device, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information.

Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

In various embodiments, the qubit encoding 110 of a projective hypersphere that represents a plurality of qubits and the quantum calculations performed by the virtual quantum computing engine 104 operate based on a projective hypersphere representation of quantum information and include a decomposition of the sublattice performed via a plurality of iterations. Consider a case where the projective hypersphere is a Riemann-hypersphere. The Riemann-sphere in its simplest form offers many advantages over the Bloch sphere as a model of single basis units of Quantum Information; it is capable of presenting all the same information with the same advantages that the Bloch sphere has for visualization, but goes much further with greater advantages in terms of dimensionality, direct representations of pure quantum states, mixed quantum states, and generalized quantum operations as rotations of the Hypersphere, and thus is more expressive for encoding the dynamics of quantum computing systems.

The Riemann-sphere is the stereographic projection of every point p in the extended Complex plane, to a point on the surface of a 2-sphere, Σ. Regardless of how the orientation of the Riemann-sphere is chosen, the complex numbers within the unit circle project to the Southern hemisphere, the points along the unit circle remain in exactly the same position along the equator, and the points outside the unit circle project to the Northern hemisphere; the North pole N becomes the stereographic projection of the point at infinity, ∞, and the South pole S becomes the stereographic projection of the point at the origin, 0.

Other orientations of the Riemann-sphere are possible, for example by choosing to define Σ to be tangent to the Complex plane at its South pole, by choosing to coincide the equator of the 2-sphere Σ with the unit-circle of the Complex plane prior to stereographic projection of the plane to the surface, etc. Stereographic projection is conformal (preserves angles), preserves senses of angles (from the perspective of an observer within the sphere), and preserves circles as well. Thus, stereographic projection of the extended complex plane to the Riemann-sphere can be represented as a Möbius transformation, and thus the representation or encoding of all states and operations on the Riemann-sphere have an equivalent representation or encoding using existing standard classical data-types such as vectors, matrices, decision diagrams, graphs, etc. While a Riemann-sphere has only three-dimensions, a Reimann-hypersphere is a higher dimensional Reimann n-sphere, in n-dimensions.

Consider a hyperlattice that represents all possible stereographic projections of the extended complex plane to the Riemann-hypersphere. In various embodiments, the input 115 is data file containing a description of the quantum problem to be solved in, for example, a traditional quantum computing representation, a graph or other topological representation, a matrix, a circuit or gate representation, or other function or other computational formulation. For example, the input 115 can be formatted in Q# (Q-Sharp), in Open Quantum Assembly language (OpenQASM) or other assembly language, other language or other text and/or data file. The encoding of the input 115 can be performed by determining a particular transformation of the input 115 to the Reimann-hypersphere. In operation, the input 115 is projected on the Reimann-hypersphere as a particular sublattice of the full hyperlattice. All possible sublattices of the full hyperlattice are guaranteed to be unique up to congruence, therefore the sublattice contains no redundancy in its encoding, up to the dimension of the hyperlattice. The hyperlattice format itself is the metamachine. By the theory of Proofs-as-Programs, the Church-Turing equivalence, and similar fundamental work in computer science, information theory, control theory, automata theory, the theory of formal languages, etc., a Hyperlattice is formally equivalent to a Quantum Turing Machine, which is more powerful than a Universal Quantum Computer, but limited by similar constraints as applies to recursively-enumerable classical Turing Machines. Embodiments of this include Quantum Logic based computers, Quantum Metamachines, Quantum Component Frameworks, Automatic Quantum Programming, Quantum Machine Learning applications, Quantum Machine Intelligence systems, classical equivalents, etc. Furthermore, encoding as a hyperlattice is a complete recursively enumerable automaton which can close over both the program and data at the same time.

This allows the virtual quantum computing engine 104 to operate based on a finite, structured representation of all possible encodings, which intrinsically self-organizes into a partially-ordered set over the equivalence classes of absolute algorithmic complexity. Given that every encoding, as a sublattice, is guaranteed by the algebraic properties of hyperlattices to be unique, each sublattice is the canonical representation of an algorithm. Complex functions map to rotations of the Riemann-hypersphere; and in general, all rotations of the Riemann-hypersphere correspond to Möbius transformations. Furthermore, Möbius transformations also correspond to matrices. The action of any complex function may be transferred to the Riemann-hypersphere by stereographic projection, providing a process for encoding an input 115 into a projective hypersphere representation. For any complex function f(z), a stereographic image can be generated. Furthermore, the transformation is reversable by the decoder 106 in generating a corresponding output 120.

The most general rotation of the Riemann-sphere can be expressed as a Möbius transformation of the form:

$$R ( z ) = \frac{a z + b}{- \overline{b} z + \overline{a}}$$

which, for example, can correspond to the unitary matrices used to define the quantum gates in the circuit model of quantum computation, but in general, are valid quantum operators in any (open or closed) quantum system and generalized quantum operations are a superset of Hermitian and Unitary quantum operations.

The quantum registers used in quantum computing, can be represented by vector space products, more literal combinations into a shared entangled state by tensor products or by composition operators. The result is identical: as individual, non-entangled qubits become entwined and enfolded (which terms are more accurate translations of Schrödinger's original German terminology), overlapping projections shadow each other, orthogonal projections are pushed as far apart as possible. So the result of each tensor product, when using the Riemann-hypersphere as a model of quantum information is at least, a projection of all the qubits in a register into a hypersphere of dimension n-1 to the length of the quantum register n.

A distinct advantage of this model is that a single, inherently geometric (and therefore visual) formalism is capable of encoding all quantum information systems, simply by interpreting the Tensor-product relation over qubits as a quantum-combinator and under its most natural and intuitive form as an inducer of orthogonality, whenever permitted. The use of a projective hypersphere model of quantum information is vastly superior to the Bloch sphere model. In the Bloch sphere model, every point within or on the surface represents a complete state-vector of probability amplitudes, pure states are represented as points on the surface and mixed states are represented as points inside the sphere. The computational basis is not represented in the points, but only as the north (top) and south poles (bottom) of the sphere. Most importantly, the Bloch sphere model can only represent one qubit. Because of the way the computational basis is encoded in the Bloch sphere model, the model cannot be generalized to multi-qubit registers the way the Riemann-hypersphere can be generalized. A 2-sphere naturally encodes only a single qubit, once the standard binary basis of Boolean logic has been substituted for the point at infinity for logical top, and its inverse zero for logical bottom.

In contrast, in the projective hypersphere model of quantum information, an arbitrary quantum register becomes an n-1 hypersphere, so a single model represents every possible quantum state to any degree of complexity, pure or mixed, entangled or otherwise for both continuous and discrete variable quantum systems. It also provides for an elegant means to represent decoherence, as a form of spectral decomposition of a hypersphere that acts on its degrees of freedom. The points on the surface of the hypersphere represent distinct quantum states. Every state has a unique inverse (the antipodal point). A state-vector is a literal vector along the surface of the Riemann-Hypersphere (i.e., a rotation operator). State-vectors encode a probabilistic state-space as an area on the surface of the hypersphere. The area is bounded by the state-vector composed with the basis vectors of the system. As bounded distributions in a complex vector-space, state-vectors can also be represented using Sato's Hyperfunctions—since Sato's Hyperfunctions are a subset of Holomorphic Functions, and are therefore infinitely differentiable. This property further allows any Hypersphere to be projected down to a 2-Sphere using a nonlinear function, such as are observed in Quantum Chaotic systems. Both the computational basis and the current time-step of a computation are preserved. As established by the field, quantum registers can be formed by the tensor product (adjacency relation over qubits), which is equivalent to an entanglement operation.

The resulting state-(hyper)space can be naturally represented by the Riemann-Hypersphere formalism, as the Riemann-Hypersphere is equal to the tensor product over the vector spaces of Riemann-spheres. Consider the following example of the tensor product of 3 qubits, encoded as the tensor product of 3 Riemann-spheres, which is equivalent to the n-sphere where n=2³⁻¹=4, projected into a d-space where d=2³=8. One can observe that both the surface area and the world-volume of the quantum state-space increase exponentially by the dimension of the computational basis to the power of the quantum register's tensor rank (for the surface area) or the quantum register's dimension (for the world-volume), exactly as expected by the theory of quantum information. Extending from above, the Riemann-hypersphere is a complete geometric encoding of quantum and classical information theory, supporting both discrete and continuous spaces, states, operations, etc. This encoding not only helps reduce the number of calculations necessary in determining the probabilities of states in superposition: it directly supports the use of Complex-valued measures and probabilities, inducing a partial order along the paths of convergence from the point at zero to the point at infinity.

Consider the further example where the input 115 represents an operation, such as a database retrieval, formatted a quantum matrix calculation in accordance with Grover's Algorithm. The encoder 102 generates the qubit encoding 110 by converting the quantum matrix calculation to a sublattice of a Reimann-hypersphere. Furthermore, the virtual quantum computing engine 104 can operate iteratively in projective hypersphere space, and via Grover's Algorithm for example, to determine the quantum solution 114.

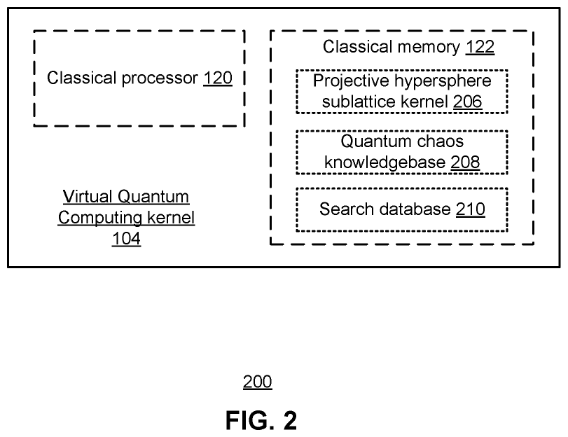

Further details regarding the operation of the virtual quantum computing engine 104 including several optional functions and features are presented in conjunction with FIG. 2 that follows.

FIG. 2 is a schematic block diagram 200 of an embodiment of a virtual quantum computing engine 104 in accordance with the present invention. The virtual quantum computing engine 104 includes a classical processor 120 and a classical memory 122. As shown, the classical memory 122 stores a projective hypersphere sublattice kernel 206, quantum chaos knowledgebase 208, and search database 210. As previously discussed, the qubit encoding 110 of a projective hypersphere that represents n qubits as a tensor product of n-hyperspheres. In various embodiments n=128, however, greater or lesser numbers of qubits can be implemented, for example, based on the expected size of the input 115. The quantum calculations performed by the projective hypersphere sublattice kernel 206 operate based on a projective hypersphere representation of quantum information to perform a decomposition of the sublattice via a plurality of iterations.

In various embodiments, the projective hypersphere sublattice kernel 206 operates via a non-linear, nondeterministic, self-tuning, and parametric or nonparametric prediction model to perform the quantum calculations. For example, the search database 210 can include one or more search techniques, including a nonlinear regression such as massively-parametric regression, a nearest-neighbor method, kernel-prediction, DIRECT search or other Bayesian or Lipshitzian search method, a genetic algorithm, Grover's algorithm, a graph search algorithm, a true-random quantum nondeterministic choice operator or other Monte Carlo algorithm, etc.

In various embodiments, the projective hypersphere sublattice kernel 206 further operates based on a heuristic algorithm that includes some or all of the following steps:

1) generate a search selection that indicates one of the search techniques;

2) perform a plurality of iterations in accordance with the search selection;

3) evaluate a result of each iteration of the subset of the plurality of iterations by:
determining an estimated distance to a universal optimum; and
an estimated cost to reach the universal optimum;

4) terminating the plurality of iterations when the estimated cost to reach the universal optimum exceeds a cost threshold; and

5) after the iterations terminate by a true-random quantum nondeterministic choice operator can be called to further refine the quantum solution.

In various embodiments, the universal optimum can be approximated, for example, based on the information entropy of the iteration result. The estimated distance to a universal optimum can be determined based on the difference between the approximation of the universal optimum and the current result. The estimated cost to reach the universal optimum can be generated, for example, by determining the magnitude of the gradient of the result and dividing the estimated distance by the gradient to estimate the number of iterations that might be required to reach the approximate universal optimum.

As previously discussed, the virtual quantum computing engine 104 can be configured to process the qubit encoding 110 to generate a quantum solution 114 using quantum calculations and based on quantum chaos generated in accordance with the quantum chaos knowledgebase 208. The quantum chaos knowledgebase 208 can be configured as a n-qubit representation of in a hyperlattice that represents all possible stereographic projections of the extended complex plane to the Riemann sphere. Superposition of the quantum chaos in this complex space with the sublattice projection of the input 115 achieves both quantum chaos and entanglement in generating the quantum solution.

In various embodiments, the quantum chaos knowledgebase 208 is generated based on machine learning. In particular, the quantum chaos knowledgebase 208 includes a machine learning engine that is trained based on a reflective multilayer bootstrapping that includes one or more initial layers of training based on a quantum device emulation performed via a classical computer that emulates or simulates quantum chaos. These results can be used to seed a refinement layer of training performed via quantum noise measurements from a quantum computer.

For example, the training can be performed on a D-Wave 2000Q as follows:

1) construct the standard noise model of the D-Wave 2000Q by statistical analysis of results when performing a standard battery of tests and using random quantum programs with known outputs;

2) the resulting noise model is used as random seed for flux bias offsets of the model;

3) correct the flux bias drift towards the noise in the gradient; and

4) repeat until the flux converges to singularity.

The algorithm above trains the quantum chaos knowledgebase 208 to generate the quantum chaos, such as type-III quantum chaos and/or other quantum noise for use by the projective hypersphere model of the projective hypersphere sublattice engine 206.

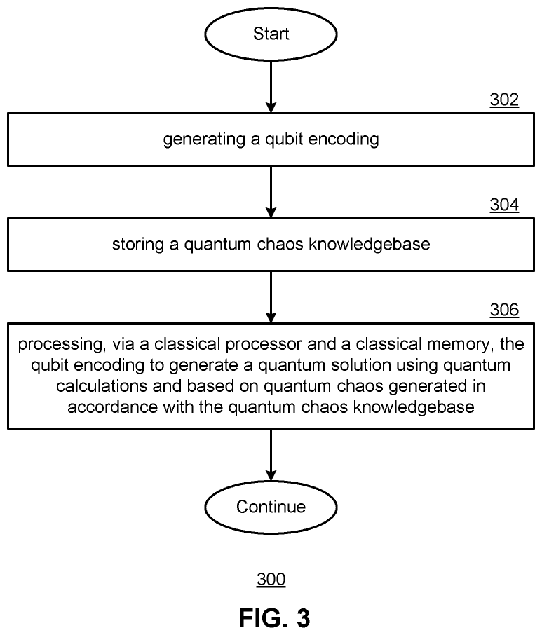

FIG. 3 is a flow diagram 300 of an embodiment of a method in accordance with the present invention. In particular, a method is presented for use with one or more functions and features described in conjunction with FIGS. 1-2. Step 302 includes generating a qubit encoding. Step 304 include storing a quantum chaos knowledgebase. Step 306 include processing, via a classical processor and a classical memory, the qubit encoding to generate a quantum solution using quantum calculations and based on quantum chaos generated in accordance with the quantum chaos knowledgebase.

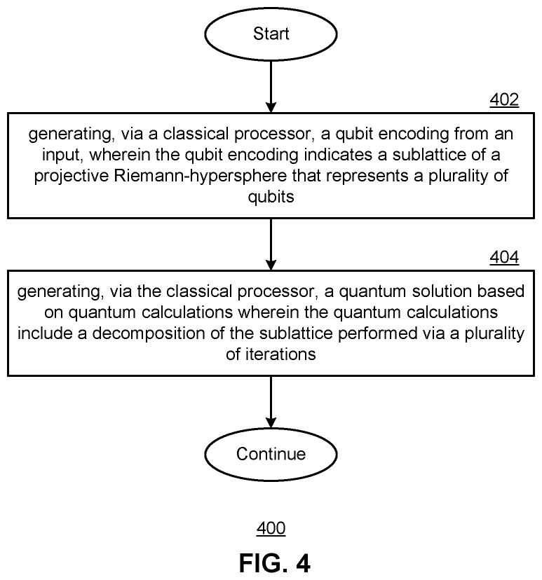

FIG. 4 is a flow diagram 400 of an embodiment of a method in accordance with the present invention. In particular, a method is presented for use with one or more functions and features described in conjunction with FIGS. 1-3. Step 402 includes generating, via a classical processor, a qubit encoding from an input, wherein the qubit encoding of a projective Riemann-Hypersphere that represents a plurality of qubits. Step 404 includes generating, via the classical processor, a quantum solution based on quantum calculations wherein the quantum calculations include a decomposition of the sublattice performed via a plurality of iterations.

In various embodiments, the quantum calculations are further based on quantum chaos generated in accordance with a quantum chaos knowledgebase. The quantum chaos knowledgebase can include a machine learning engine trained via first layer of training based on a quantum device emulation performed via a classical computer and at least one second layer of training performed via a quantum computer. The quantum chaos can include type-III quantum chaos. The quantum chaos knowledgebase can represent the quantum chaos in the projective Riemann-Hypersphere that represents the plurality of qubits. The quantum calculations can superimpose the quantum chaos on the sublattice. In various embodiments, the plurality of iterations are performed in accordance with a search algorithm and/or in accordance with a non-linear prediction model.

The virtual quantum computing kernel 104 and methods described herein can be referred to as a quantum virtualization technology that provides several additional advantages over traditional classical and quantum computing architectures. Quantum virtualization technology can be implemented on classical systems in a fashion that is isomorphic between quantum hardware and classical hardware/software-virtualization. For example, quantum virtualization technology can be implemented by means of: native quantum hardware, quantum simulation in quantum software, quantum virtualization in classical hardware (i.e., quantum virtual machine implemented using an FPGA, ASIC, or Domain-Specific Architecture Microprocessor); and/or quantum virtualization in classical software (i.e., quantum virtual machine) implemented in both hardware and software. The virtual quantum computing kernel 104 can provide a higher-level architecture than existing alternatives, more like a “quantum Lisp machine” than the more primitive gate-model systems because classical Lisp machines were designed to have as machine language the kernel for the high-level programming language Lisp, which eliminated most of the compilation process and greatly increased performance.

Quantum virtualization technology, while behaviorally identical to native quantum hardware solutions differ from native quantum hardware solutions and furthermore from simulation and emulation technology. For example, quantum virtualization technology can be implemented by using an encoded database of sampled quantum states, which is queried for results instead of computing them. This query method for retrieving quantum states can be implemented similar to Dynamic Programming, memorization, function caching, and similar optimization techniques from classical computing. The structure of the encoding of the encoded database of sampled quantum states can be selected based on the problem set for which it is be used. When a computational problem exists as a proper subset of the domain spanned by a given database of quantum states, it is possible to achieve the “real-time” constant-factor scaled performance. The worst-case performance of this technique is the same as classical simulation of quantum algorithms for the first run—if the database of quantum states does not already contain a query result, it must be computed classically. However, the system can learn, bootstrap itself, and increase the size and complexity of quantum problems it can handle over time. After training, this results in a constant scale factor and constant query-time to retrieve the quantum states from memory or disk.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A quantum computing system comprising:
at least one classical processor configured by operational instructions stored in a classical memory to perform operations including:
generate a qubit encoding from an input, wherein the qubit encoding indicates a sublattice of a projective Riemann-hypersphere that represents a plurality of qubits; and
generate a quantum solution based on quantum calculations wherein the quantum calculations include a decomposition of the sublattice performed via a plurality of iterations.

2. The quantum computing system of claim 1, wherein the quantum calculations are further based on quantum chaos generated in accordance with a quantum chaos knowledgebase.

3. The quantum computing system of claim 2, wherein the quantum chaos knowledgebase includes a machine learning engine.

4. The quantum computing system of claim 3, wherein the machine learning engine is trained based on a reflective multilayer bootstrapping.

5. The quantum computing system of claim 4, wherein the reflective multilayer bootstrapping includes at least one first layer of training based on a quantum device emulation performed via a classical computer and at least one second layer of training performed via a quantum computer.

6. The quantum computing system of claim 2, wherein the quantum chaos includes type-III quantum chaos.

7. The quantum computing system of claim 2, wherein the quantum chaos knowledgebase represents the quantum chaos in the projective Riemann-hypersphere that represents the plurality of qubits.

8. The quantum computing system of claim 2, wherein the quantum calculations superimpose the quantum chaos on the sublattice.

9. The quantum computing system of claim 1, wherein the classical memory further stores a search database that includes a plurality of search techniques, wherein the classical processor generates a search selection that indicates one of the plurality of search techniques and wherein the plurality of iterations are performed in accordance with the search selection.

10. The quantum computing system of claim 9, wherein the classical processor evaluates a result of each iteration of the plurality of iterations by:
determining an estimated distance to a universal optimum;
an estimated cost to reach the universal optimum; and
terminating the plurality of iterations when the estimated cost to reach the universal optimum exceeds a cost threshold.

11. The quantum computing system of claim 10, wherein, when the estimated cost to reach the universal optimum exceeds the cost threshold, the classical processor terminates the plurality of iterations by calling a true-random quantum nondeterministic choice operator.

12. The quantum computing system of claim 1, wherein the qubit encoding is generated by projecting a quantum matrix calculation to the sublattice of the projective Riemann-hypersphere.

13. A method comprising:
generating, via a classical processor, a qubit encoding from an input, wherein the qubit encoding indicates a sublattice of a projective Riemann-hypersphere that represents a plurality of qubits; and
generating, via the classical processor, a quantum solution based on quantum calculations wherein the quantum calculations include a decomposition of the sublattice performed via a plurality of iterations.

14. The method of claim 13, wherein the quantum calculations are further based on quantum chaos generated in accordance with a quantum chaos knowledgebase.

15. The method of claim 14, wherein quantum chaos knowledgebase includes a machine learning engine trained via first layer of training based on a quantum device emulation performed via a classical computer and at least one second layer of training performed via a quantum computer.

16. The method of claim 14, wherein the quantum chaos includes type-III quantum chaos.

17. The method of claim 14, wherein the quantum chaos knowledgebase represents the quantum chaos in the projective Riemann-hypersphere that represents the plurality of qubits.

18. The method of claim 14, wherein the quantum calculations superimpose the quantum chaos on the sublattice.

19. The method of claim 13, wherein the plurality of iterations are performed in accordance with a search algorithm.

20. The method of claim 13, wherein the plurality of iterations are performed in accordance with a non-linear prediction model.
